(19) United States
(12) Patent Application Publication
(10) Pub. No.: US 2025/0351996 A1
(43) Pub. Date: Nov. 20, 2025

(54) OVEN STRUCTURE

(71) Applicant: KING CHUNE INDUSTRIAL CO., LTD., New Taipei City (TW)

(72) Inventor: I-JUI CHANG, New Taipei City (TW)

(21) Appl. No.: 18/665,520

(22) Filed: May 15, 2024

(51) Int. Cl. A47J 37/04; A47J 36/32; A47J 37/06; F24C 3/08; F24C 3/12

(52) U.S. Cl. CPC A47J 37/043; A47J 36/32; A47J 37/0647; A47J 37/0664; F24C 3/087; F24C 3/128; A47J 2202/00

(57) ABSTRACT

An oven structure includes a main body, a digital temperature control unit, a container, and tonging unit. The main body is provided, on a front side, with a front cover movable for opening and closing. The digital temperature control unit includes a touch screen, and also a power button, a motor control button, setting buttons, a timer button, and a probe control button. The container is movably placed in the main body. The tonging unit is removably connected with the container. The front cover effectively blocks winds that influence heating flaming inside the oven. The digital temperature control unit helps prevent food from being overheated, makes heating temperature uniform, enables setting of the oven temperature and the heating time, accurately detects and control meat heating temperature to improve heating performance. The tonging unit is connectable with the container for moving the container into and out of the oven.

### BACKGROUND OF THE INVENTION

### (a) Technical Field of the Invention

The present invention relates to an oven, and more particularly to an over structure that provides a sealing effect to effectively blocks winds that influence baking flaming in the interior of the oven, prevents food from being overcooked, makes heating temperature uniform, and enables setting of an oven temperature and a heating time, and accurately detects and controls a heating temperature for meats to improve heating performance, and allows a tonging unit to serve, in addition to a utensil for tonging foodstuffs, a burning protection tool for the container.

### (b) Description of the Prior Art

Diet is necessary and vital daily activity for life supporting and body nourishing. Food has to be taken daily and has also to be delicious for enjoyable swallow and pleasure of dinning. Thus, properly handling foodstuff and setting up cooling ovens and dinning and cooking utensils must be fulfilled. Among various cooking styles, roasting or baking food is one of the popular and long-known ways of cooking. Sole roasting or baking, without preparation for water steaming and heating, is particularly suitable for small-scale or large-scale outdoor activity and is a convenient way for having hot food timely.

As such, ovens are commonly employed in daily activity for preparing delicious food, and ovens are virtually a must for daily living.

A traditional oven often includes a burner for heating through burning or heating through thermal radiation. Such a known oven suffers certain shortcomings, as follows:
(1) The oven includes a cover, which has an opening/closing structure that has a poor effect of sealing and cannot effectively block external airflows that may influence heating flames inside the oven, and consequently, a longer period of time for heating may be necessary and more fuel may be consumed for heating.
(2) Activation/deactivation of the function of heating, as well as regulation of heating flames, is fulfilled with a simply-structured switch. Consequently, overcooking of food, nonuniform heating temperature, and poor heating performance may result.
(3) Pots or containers that hold food may have a high temperature on the surface once placed in the oven and heated, and a user needs certain tools for burning protection to move the pots or containers into or out of the oven to protect the user's hands from burning. And, this causes certain problems for roasting or baking, and extra money must be spent for such burning protection tools.

As such, the known oven is not perfect and further improvement is needed.

The present invention is made to overcome the above-discussed problems of the known ovens.

### SUMMARY OF THE INVENTION

An objective of the present invention is to provide an oven structure that provides a sealing effect to effectively blocks winds that influence baking flaming in the interior of the oven, prevents food from being overcooked, makes heating temperature uniform, and enables setting of an oven temperature and a heating time, and accurately detects and controls a heating temperature for meats to improve heating performance, and allows a tonging unit to serve, in addition to a utensil for tonging foodstuffs, a burning protection tool for the container.

To achieve the above objective, the present invention provides an oven structure that comprises a main body, a digital temperature control unit, a container, and a tonging unit, wherein the main body comprises a heating space formed in an interior thereof, the main body being provided, on a front side, with a front cover, the front cover being movable between an opened state and a closed state to selectively cover and shield the heating space; the digital temperature control unit is arranged on an outside surface of the main body, the digital temperature control unit comprising a temperature control circuit arranged in an interior thereof, the digital temperature control unit comprising a touch screen arranged on an outside thereof, wherein the touch screen is operable to display an oven heating temperature value, the digital temperature control unit comprising a power button, a motor control button, at least one setting button, a timer button, and a probe control button, wherein the power button is operable to control activation/deactivation of the digital temperature control unit; the motor control button is operable to control activation/deactivation of rotation of a motor; the at least one setting button is operable to adjust and set an oven temperature and a heating time; and the probe control button is operable to control activation/deactivation of a meat probe, and the at least one setting button is operable to set up a set temperature of the meat probe; the container is placeable, in a movable manner, in the interior of the main body, the container being provided, on a front side, with a connection plate, the connection plate being formed with two connection holes, the connection holes each having a lower sidewall that is formed with a first positioning portion and a second positioning portion, each of which is formed by recessing the lower sidewall in a notched form, a guide slope being arranged to connect between the first positioning portion and the second positioning portion; and the tonging unit is removably connectable with the container, the tonging unit comprising two tonging arms that are made of a material of flexibility, wherein the two tonging arms, once acted upon by inward pressing forces toward each other, are caused to move inwards from an original, separated state to approach each other and once the pressing forces are removed, the two tonging arms spring back to the original separated state, the tonging arms having end portions that are provided, on each of upper and lower edges thereof, with a stop portion, the end portions of the tonging arms being insertable into the connection holes, such that the two tonging arms, when acted upon by the inward pressing forces to move inwards, are caused to move along the guide slope from the first positioning portion toward the second positioning portion to be retained in the second positioning portion, where the stop portions of the upper and lower edges of the end portions are set in retaining engagement with surfaces of the connection plate on upper and lower sides of the connection holes.

The front cover provides a sealing effect that effectively blocks winds that influence the heating flaming in the interior of the oven, and the heating time can be shortened.

The digital temperature control unit helps prevent food from being overheated and makes the heating temperature uniform and is operable to regulate the heating time and temperature, and may accurately detect and thus control a heating temperature of meat to thereby enhance deliciousness of food and also to improve heating performance.

The tonging unit may serve as a tool for tonging and gripping foodstuffs, and the tonging unit may also be connectable to and/from disconnectable from the container that holds food therein to enable easy movement of the container into and/or out of the oven, and can thus serve as a burning protection tool for the container to thereby enhance operation convenience and measures for burning protection.

A detailed description is provided below with reference to embodiments, in combination with the attached drawings, for illustrating the present invention so as to enable better understanding of functionality and feature of the present invention.

### BRIEF DESCRIPTION OF THE DRAWINGS

FIG. 1 is a perspective view showing a main body of an oven according to the present invention.

FIG. 1A is an enlarged view of an encircled portion 1A of FIG. 1.

FIG. 2 is a perspective view showing a container according to the present invention.

FIG. 3 is a perspective view showing a tonging unit according to the present invention.

FIG. 4 is a schematic view showing an example of use of the container and the tonging unit according to the present invention.

FIG. 5 is an exploded view showing a drive structure of a rotary tray according to the present invention.

FIG. 6 is a schematic view showing an example of use of an external portable power supply with a digital temperature control unit according to the present invention.

### DETAILED DESCRIPTION OF THE PREFERRED EMBODIMENTS

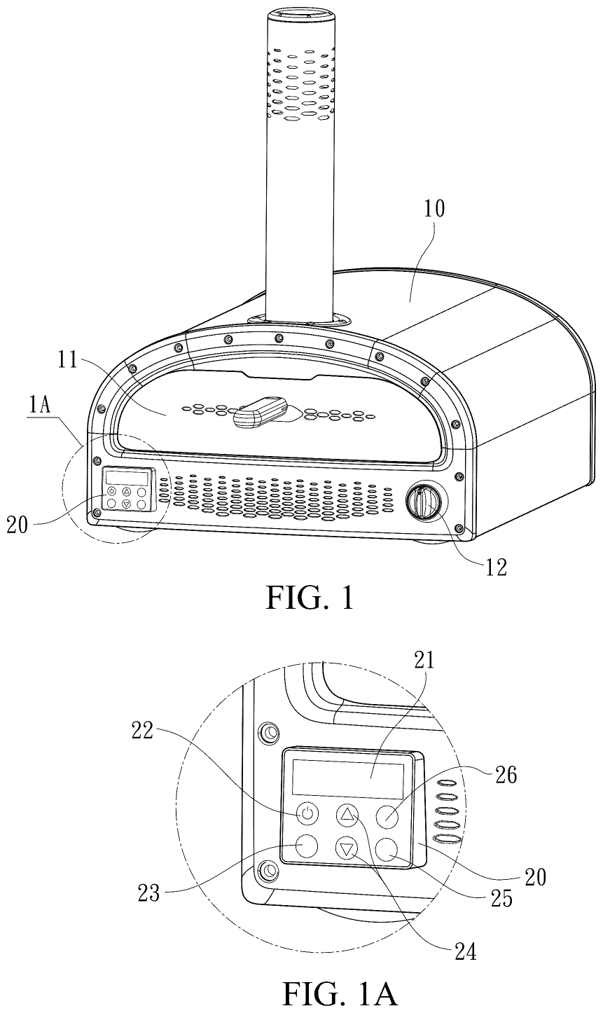

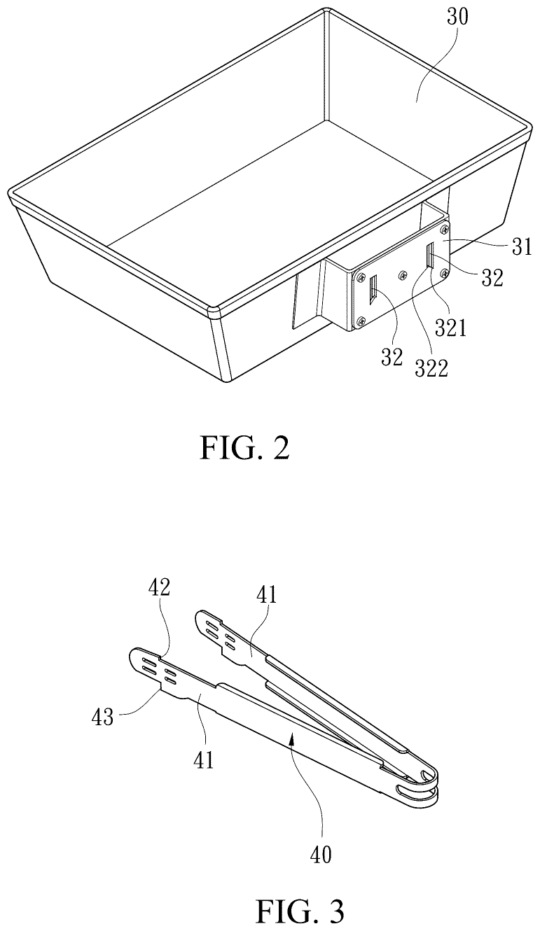

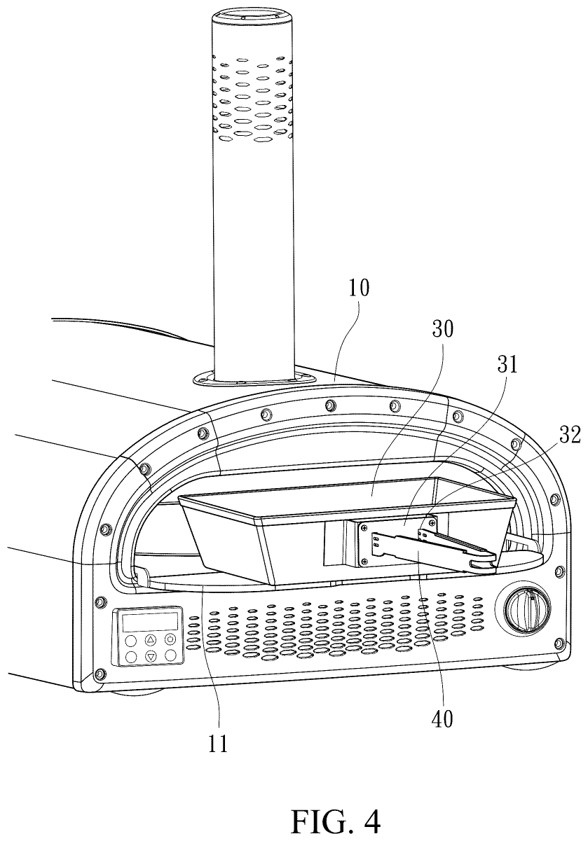

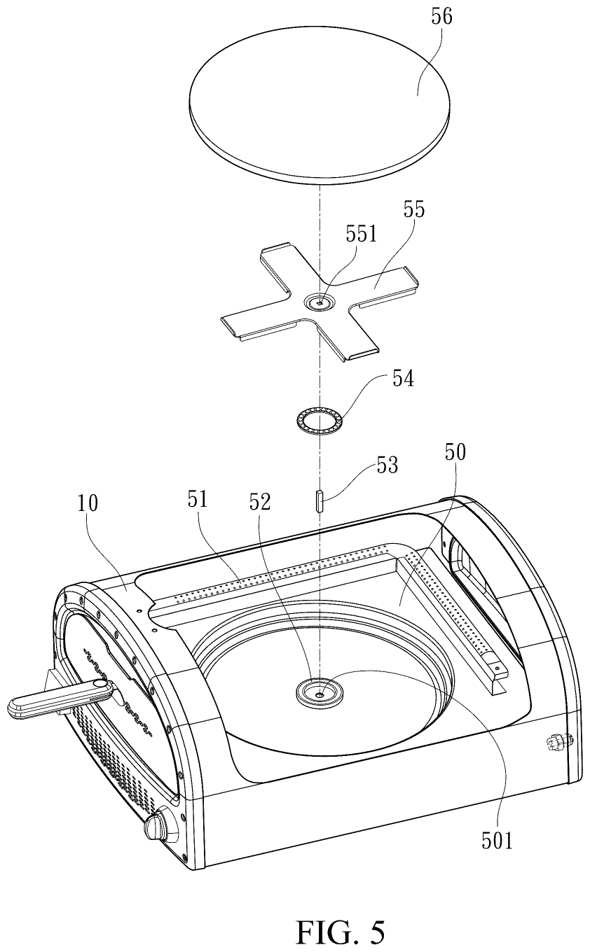

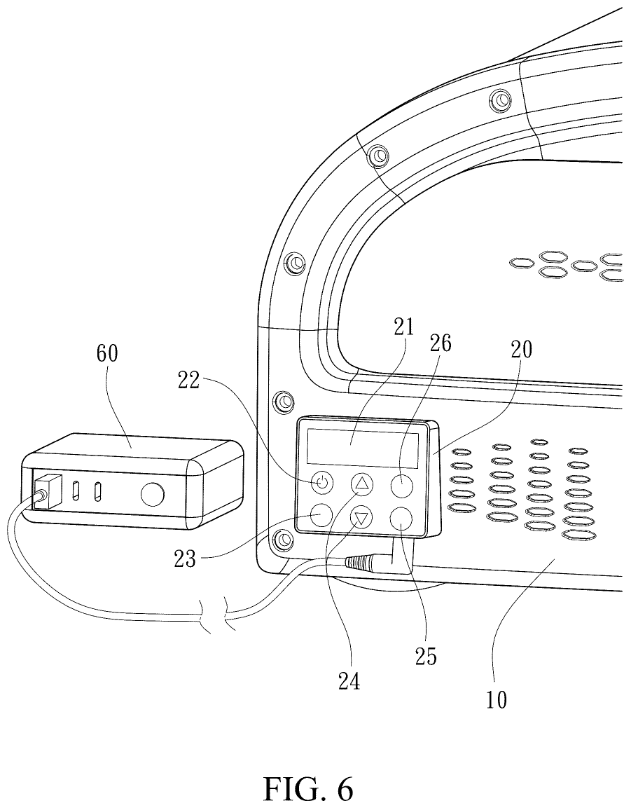

Referring to FIGS. 1-6, the present invention provides an oven structure that comprises a main body 10, a digital temperature control unit 20, a container 30, and a tonging unit 40. Details are provided below.

The main body 10 includes a heating space formed in an interior thereof. The main body 10 is provided, on a front side, with a front cover 11. The front cover 11 is movable between an opened state and a closed state to selectively cover and shield the heating space.

The digital temperature control unit 20 is arranged on an outside surface of the main body 10. The digital temperature control unit 20 includes, arranged in an interior thereof, a temperature control circuit. The digital temperature control unit 20 includes, arranged on an outside thereof, a touch screen 21. The touch screen 21 is operable to display an oven heating temperature value. The digital temperature control unit 20 also includes a power button 22, a motor control button 23, at least one setting button 24 of which two such setting buttons are shown in the drawings, a timer button 25, and a probe control button 26. The power button 22 is operable to control function activation/deactivation of the digital temperature control unit 20. The motor control button 20 is operable to control function activation/deactivation of a motor for rotating a rotary tray to be described hereinafter. The setting buttons 24 are operable to adjust or set the oven temperature and/or the heating time. The probe control button 26 is operable to control function activation/deactivation of a meat probe, which is arranged in the interior of the main body 10, but is well known, so that further details of the meat probe will be omitted. The setting buttons 24, as indicated by the up and down arrows shown in the drawings, are also operable to set up a desired temperature of the meat probe.

The container 30 is placeable, in a movable manner, in the interior of the main body 10. The container 30 is provided, on a front side, with a connection plate 31. The connection plate 31 is formed with two connection holes 32. The connection holes 32 each have a lower sidewall that is formed with a first positioning portion 321 and a second positioning portion 322, preferably on two opposite sides of the lower sidewall, and each being formed by recessing the lower sidewall in a notched form. A guide slope is arranged to connect between the first positioning portion 321 and the second positioning portion 322.

The tonging unit 40 is removably connectable with the container 30. The tonging unit 40 includes two tonging arms 41 that are made of a material of flexibility. Once acted upon by inward pressing forces, the two tonging arms 41 are moved inwards from an original, released and separated state to approach each other, and once the pressing forces are removed, the two tonging arms 41 spring back to the original, released and separated state. Each, or at least one, of the tonging arms 41 has an end portion having an upper edge and a lower edge each of which is formed with a stop portion 42, 43 facing in opposite directions. The end portions of the tonging arms 41 are respectively insertable into and through the connection holes 32, and when the two tonging arms 41 are acted upon by the pressing forces to move inwards, the end portions move along the guide slope from the first positioning portion 321 toward and thus become retained in the second positioning portion 322, so that the stop portions 42, 43 are set in retaining engagement with and thus held in position by upper and lower sides of the connection holes 32 of the connection plate 31. As the stop portions 42, 43 are set to face opposite directions, the stop portions 42, 43 are in contact engagement with two opposite surfaces of the connection plate 31.

As such, the end portions of the tonging arms 41 are set in retaining engagement with and thus connected to the second positioning portions 322, and this allows the tonging unit 40 to be securely connected to the container 30 that may hold food to be processed therein, and undesired separation may be avoided between the tonging unit and the container in such a condition that the tonging arms are pressed inwards and toward each other by the pressing forces.

After the pressing forces acting on the tonging arms 41 are removed, the two tonging arms 41 elastically springs back to the original state, allowing the end portions of the tonging arms 41 to return from the second position portion 322 to the first positioning portion 321, and under such a condition, the tonging unit 40 is detachable from the container 30 and separation between the two can be easily achieved.

In one embodiment, the main body 10 is provided, on an outside thereof, with a rotary control knob 12, which is operable to regulate and control heating flaming in the interior of the main body 10.

In one embodiment, the main body 10 is provided, in the interior thereof, with a base 50. The base 50 is provided with a burner 51 and a bearing holder 52. The base 50 is also formed with a motor spindle hole 501. The motor spindle hole 501 is arranged on or corresponding to a motor arranged inside the main body. The motor is controllable by the digital temperature control unit 20. A spindle bar 53 is arranged in the motor spindle hole 501. A roller ball ring 54, which includes roller balls, is disposed in the bearing holder 52. A rotary rack 55 is arranged on and supported by the roller ball ring 54. The rotary rack 55 is formed with a coupling hole 551, and the coupling hole 551 is fit to and coupled with the spindle bar 53, so that the rotary rack 55 is driven, through the spindle bar 53, by the motor to rotate. A rotary tray 56 is disposed on and supported by the rotary rack 55, and the rotary tray 56 receives the container 30 to place thereon and support thereby. When the rotary rack 55 is driven to rotate, the rotary tray 56 and the container 30 are caused to rotate in unison therewith.

In one embodiment, the rotary rack 55 is provided, on an undersurface thereof with a holding portion that engages with and holds the roller ball ring 54 so as to be rotatably supported by the roller balls of the roller ball ring in a movable manner.

As such, a user may operate the motor control button 23 of the digital temperature control unit 20 to control function activation/deactivation of rotation of the rotary tray 56, in order to make heating temperature in the interior of the oven more uniformly distributed.

It is noted that the bearing holder 52, the roller ball ring 54, and the holding portion on the undersurface of the rotary rack 55 jointly form a bearing structure, which reduces the friction for the rotation of the rotary rack 55 and helps improve smoothness of rotation of the rotary rack 55, so as to reduce and balance weight and forces acting on the rotary tray 56 to thereby reduce the rate of damage of the motor.

In one embodiment, the rotary rack 55 is made in a cruciform configuration.

In one embodiment, the burner 51 is made in an L-shaped form.

As such, the heating temperature in the interior of the oven is made more uniform.

In one embodiment, the digital temperature control unit 20 is electrically connectable to a portable power supply 60.

As such, the portable power supply 60 supplies electrical power to the digital temperature control unit 20, or alternatively, batteries are used to supply electrical power to the digital temperature control unit 20.

The above provides a description to components/parts of the present invention, and assembly thereof, and in the following, examples of use, advantages, and efficacy of the present invention will be discussed in detail.

The front cover 11 provides a sealing effect that effectively blocks winds that influence the heating flaming in the interior of the oven, and the heating time can be shortened.

The digital temperature control unit 20 helps prevent food from being overheated and makes the heating temperature uniform and is operable to regulate the heating time and temperature, and once the heating time reaches a preset level, the temperature control unit 20 may issue alarm sounding. Further, the probe control button 26 is arranged so that a meat probe may accurately detect and thus control a heating temperature of meat to thereby enhance deliciousness of food and also to improve heating performance.

The tonging unit 40 may serve as a tool for tonging and gripping foodstuffs, and the tonging unit 40 may also be connectable to and/from disconnectable from the container 30 that holds food therein to enable easy movement of the container 30 into and/or out of the oven, and can thus serve as a burning protection tool for the container 30 to thereby enhance operation convenience and measures for burning protection.

The embodiments provided above are only for illustration and simplification of the description of the present invention, and should not be construed limiting to the scope of the present invention, and all variations that are available from the description of the present invention as defined in the appended claims are considered falling in the scope of protection defined by the claims.

I claim:

1. An oven structure, comprising:
a main body, which comprises a heating space formed in an interior thereof, the main body being provided, on a front side, with a front cover, the front cover being movable between an opened state and a closed state to selectively cover and shield the heating space;
a digital temperature control unit, which is arranged on an outside surface of the main body, the digital temperature control unit comprising a temperature control circuit arranged in an interior thereof, the digital temperature control unit comprising a touch screen arranged on an outside thereof, wherein the touch screen is operable to display an oven heating temperature value, the digital temperature control unit comprising a power button, a motor control button, at least one setting button, a timer button, and a probe control button, wherein the power button is operable to control activation/deactivation of the digital temperature control unit; the motor control button is operable to control activation/deactivation of rotation of a motor; the at least one setting button is operable to adjust and set an oven temperature and a heating time; and the probe control button is operable to control activation/deactivation of a meat probe, and the at least one setting button is operable to set up a set temperature of the meat probe;
a container, which is placeable, in a movable manner, in the interior of the main body, the container being provided, on a front side, with a connection plate, the connection plate being formed with two connection holes, the connection holes each having a lower sidewall that is formed with a first positioning portion and a second positioning portion, each of which is formed by recessing the lower sidewall in a notched form, a guide slope being arranged to connect between the first positioning portion and the second positioning portion; and
a tonging unit, which is removably connectable with the container, the tonging unit comprising two tonging arms that are made of a material of flexibility, wherein the two tonging arms, once acted upon by inward pressing forces toward each other, are caused to move inwards from an original, separated state to approach each other and once the pressing forces are removed, the two tonging arms spring back to the original separated state, the tonging arms having end portions that are provided, on each of upper and lower edges thereof, with a stop portion, the end portions of the tonging arms being insertable into the connection holes, such that the two tonging arms, when acted upon by the inward pressing forces to move inwards, are caused to move along the guide slope from the first positioning portion toward the second positioning portion to be retained in the second positioning portion, where the stop portions of the upper and lower edges of the end portions are set in retaining engagement with surfaces of the connection plate on upper and lower sides of the connection holes.

2. The oven structure according to claim 1, wherein the main body is provided, on an outside thereof, with a rotary control knob, which is operable to regulate and control heating flaming in the interior of the main body.

3. The oven structure according to claim 1, wherein the main body is provided, in the interior thereof, with a base, the base comprising a burner and a bearing holder, the base being formed with a motor spindle hole, the motor spindle hole being arranged on the motor, the motor being controllable by the digital temperature control unit, a spindle bar being received in the motor spindle hole, a roller ball ring being disposed in the bearing holder, a rotary rack being arranged on the roller ball ring, the rotary rack being formed with a coupling hole, wherein the coupling hole is fit to and coupled with the spindle bar, so that the rotary rack is driven through the spindle bar by the motor to rotate, a rotary tray being arranged on and supported by the rotary rack, the rotary tray receiving the container to dispose thereon, wherein when the rotary rack is driven to rotate, the rotary tray and the container are caused to rotate in unison therewith.

4. The oven structure according to claim 3, wherein the rotary rack is provided, on an undersurface thereof with a holding portion that is set in engagement with roller balls of the roller ball ring in a movable manner.

5. The oven structure according to claim 3, wherein the rotary rack is of a cruciform configuration.

6. The oven structure according to claim 3, wherein the burner is of an L-shape.

7. The oven structure according to claim 1, wherein the digital temperature control unit is electrically connectable with a portable power supply.
